(19) United States
(12) Patent Application Publication
(10) Pub. No.: US 2009/0075033 A1
(43) Pub. Date: Mar. 19, 2009

(54) Building wrap for use in external wall assemblies having wet-applied facades

(76) Inventors: Theresa Ann Weston, Richmond, VA (US); Barbara Klimowicz O'Rourke, Newark, DE (US); Mieczyslaw (Michel) Stachnik, Luxembourg (FR); Warren Francis Knoff, Richmond, VA (US); Wazir Nobbee, Chesterfield, VA (US); Kimdolyn Boone, Richmond, VA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/900,996

(22) Filed: Sep. 14, 2007

(51) Int. Cl. B32B 3/26; E04B 1/64

(52) U.S. Cl. 428/195.1; 52/741.3; 52/408

(57) ABSTRACT

A multiple sheet building wrap for wrapping the structural components of a building in order to protect the underlying structural components from moisture is provided. The building wrap is particularly useful under facades such as wet applied stucco or engineered stone, demonstrating good drainage of liquid water and moisture vapor permeability. The building wrap is a composite of a water resistive barrier and a porous intervening layer which acts as a barrier to stucco as it is applied. An exterior wall construction incorporating such building wrap is also provided.

### BACKGROUND OF THE INVENTION

1. Field of the Invention

The present invention relates to a building wrap for wrapping the structural components of a building in order to protect the structural components and optional building sheathing from moisture.

2. Description of the Related Art

Two sheets of a water resistive barrier (“WRB,” also commonly referred to as “weather-resistive barrier” or “house wrap”) material are known for use as a building wrap under facade materials such as, for example, three-coat stucco or traditional Portland cement which are applied wet, e.g., using a trowel or by spraying. For instance, such building wraps can include two layers of Grade D building paper, two layers of asphalt-saturated kraft paper, two layers of building felt, two layers of a conventional polymeric house wrap, or one layer of building paper combined with one layer of polymeric house wrap. Known polymeric house wraps for use as WRBs include, for example, spunbond polyethylene sheet available under the trade name DuPont™ Tyvek® HomeWrap® from E. I. du Pont de Nemours & Co., Wilmington, Del. (“DuPont”); polyolefin nonwoven sheet available under the trade name Styrofoam™ Weathermate™ Plus from The Dow Chemical Company, Midland, Mich.; spunbonded polypropylene-microporous film laminate available under the trade name Typar® Weather Protection Membrane from Fiberweb, London, UK; woven polypropylene sheet with a perforated coating available under the trade name Pinkwrap® from Owens Corning, Corning, N.Y.; and coated nonwoven sheet available under the trade name WeatherSmart™ from Fortifiber Building Systems Group, Reno, Nev. The space between the two layers provides a drainage space for any liquid water that penetrates the outer layer.

Currently, the International Building Code®, published by International Code Council, requires the use of “weather-resistant barriers” behind stucco facades as follows:
2510.6 Weather-resistant barriers. Weather-resistant barriers shall be installed as required in Section 1404.2 and, where applied over wood-based sheathing, shall include a weather-resistant vapor-permeable barrier with a performance at least equivalent to two layers of Grade D paper.
Exception: Where the weather resistant barrier that is applied over wood-based sheathing has a water resistance equal to or greater than that of 60 minute Grade D paper and is separated from the stucco by an intervening, substantially non-water-absorbing layer or drainage space.

It would be desirable to have an alternative, economical building wrap capable of meeting the requirements of building code for use under wet-applied stucco that would retain good drainage of liquid water, moisture vapor permeability and that would protect the underlying building structure from the penetration of liquid water. It would also be desirable to have an economical process for installing such building wraps.

### BRIEF SUMMARY OF THE INVENTION

The present invention is directed to a multiple sheet building wrap for wrapping the structural components of a building in order to protect the structural components and optional sheathing from moisture. According to one embodiment of the invention, the building wrap comprises:
a. a moisture vapor permeable water-resistive barrier; and
b. an intervening layer comprising a porous, liquid permeable sheet having a maximum pore size of between about 20 micrometers and about 150 micrometers and having a hydrostatic head of less than 10 cm selected from the group consisting of woven fabrics, spunbond nonwoven sheets, spunlaced nonwoven sheets, spunbond-meltblown nonwoven sheets, water-absorbent fibrous layers, spunbond-meltblown-spunbond nonwoven sheets and perforated films;
wherein the water resistive barrier and the intervening layer are not fully adhered, so that a drainage space is provided between the water resistive barrier and the intervening layer through which liquid water can pass.

According to another embodiment of the invention, building wrap comprises:
a. a moisture vapor permeable water-resistive barrier; and
b. a wettable intervening layer comprising:
   i. a moisture vapor permeable sheet having a maximum pore size of between about 1 micrometer and about 150 micrometers selected from asphalt-saturated papers, felts, nonwoven fabrics, perforated coated sheets comprising woven tapes, perforated films, laminates thereof, and laminates comprising a nonwoven or woven fabric and a porous moisture vapor permeable film; and
   ii. a water-absorbent fibrous layer having a hydrostatic head of less than 10 cm; wherein the moisture vapor permeable sheet and the water-absorbent fibrous layer are combined in such manner that the moisture vapor permeability of the intervening layer is not impeded.

The invention is also directed to a process of wrapping the structural components and optional sheathing of a building with the multiple sheet building wrap in order to protect the building structure from moisture.

The invention is also directed to a multiple sheet building wrap as described above, further comprising a lath layer adjacent the intervening layer, wherein the water resistive barrier, the intervening layer and the lath layer are attached.

The invention is also directed to an external wall assembly of a building utilizing the multiple sheet building wrap as described above.

### DETAILED DESCRIPTION OF THE INVENTION

The terms “nonwoven fabric”, “nonwoven sheet”, “nonwoven layer”, and “nonwoven web” as used herein refer to a structure of individual strands (e.g. fibers, filaments, or threads) that are positioned in a random manner to form a planar material without an identifiable pattern, as opposed to a knitted or woven fabric. The term “fiber” is used herein to include staple fibers as well as continuous filaments. Examples of nonwoven fabrics include meltblown webs, spunbond nonwoven webs, flash spun webs, staple-based webs including carded and air-laid webs, spunlaced webs, and composite sheets comprising more than one nonwoven web.

The term “plexifilamentary” as used herein, means a three-dimensional integral network or web of a multitude of thin, ribbon-like, film-fibril elements of random length and with a mean film thickness of less than about 4 micrometers and a median fibril width of less than about 25 micrometers. In plexifilamentary structures, the film-fibril elements are generally coextensively aligned with the longitudinal axis of the structure and they intermittently unite and separate at irregular intervals in various places throughout the length, width and thickness of the structure to form a continuous three-dimensional network. A nonwoven web of plexifilamentary film-fibril elements is referred to herein interchangeably as a “flash spun plexifilamentary sheet” and a “plexifilamentary film-fibril sheet.” Examples of plexifilamentary film-fibril structures are flash-spun polyolefin sheet sold by DuPont under the trade name DuPont™ Tyvek® HomeWrap® and DuPont™ Tyvek® StuccoWrap®.

The term “water-resistive barrier” (also referred to herein as “WRB”) refers to a material behind an exterior wall covering of a building that resists liquid water that has penetrated behind the exterior covering from further intruding into the exterior wall assembly. As defined herein, a WRB is capable in its as-received condition (i.e., not subjected to weathering) of meeting the water resistance, moisture vapor permeability and strength requirements of Acceptance Criteria for Water-Resistive Barriers AC38 (effective date Jul. 1, 2004), published by ICC Evaluation Service, Inc., Whittier, Calif.

In one embodiment, the present invention relates to a multiple sheet building wrap for wrapping the sheathing and/or structural components of a building in order to protect the components from liquid water penetration, especially for use in buildings having wet-applied facades such as traditional three-coat stucco or engineered stone (herein referred to interchangeably as “stucco”). The multiple sheet building wrap of the invention is moisture vapor permeable so that any moisture on the interior of the building wrap, e.g., moisture contacting the sheathing or structural components wrapped by the building wrap, is permitted to dry.

The multiple sheet building wrap includes a moisture vapor permeable WRB layer, an intervening layer (also referred to as “IL”) and a drainage space between the WRB layer and the intervening layer. For clarification purposes, it should be noted that the inside surface of the WRB layer is positioned relatively closer to the building and the IL is positioned adjacent to the opposite outside surface of the WRB, relatively farther from the building. The WRB may be referred to as being positioned behind or underneath the IL The terms “outer”, “outside” or “exterior” indicate locations farther away from the building and the terms “inner”, “inside” or “interior” indicate locations relatively closer to the building.

Liquid water which may happen to penetrate from the exterior of the wall assembly is directed within the intervening layer to the bottom of the wall assembly where it is directed to the exterior of the building. The water could also pass through the intervening layer and be directed by the WRB layer (without wetting the WRB layer) vertically in the drainage space between the intervening layer and the WRB layer as a result of gravity to the bottom of the wall where it is directed to the exterior of the building. The intervening layer is preferably wettable. The layers of the building wrap can be nonabsorbent, facilitating drying through diffusion. The capacity of the building wrap of the invention for drainage and drying make it particularly well suited for use with stucco facades, aiding in the curing of the stucco so that the resulting stucco facade has good flexural strength and reduced incidence of shrinkage cracking.

The intervening layer acts as a barrier or filter layer which does not allow significant penetration of stucco therethrough. Stucco penetration is undesirable as it hinders liquid water drainage and moisture vapor permeability of the building wrap. The degree of penetration of stucco through the intervening layer depends on the porosity and water absorbance of the IL material, the size of the particles in the stucco mixture, and the pressure at which the stucco is applied.

### Water Resistive Barrier (WRB) Layer

WRB layers suitable for use in the building wrap of the invention are capable in their initial, as-received condition of meeting the water resistance, moisture vapor permeability and strength requirements of Acceptance Criteria for Water-Resistive Barriers AC38 (effective date Jul. 1, 2004). The WRB layer is permeable to moisture vapor, having an average moisture vapor transmission rate of at least 35 g/m² per 24 hours.

Suitable moisture vapor permeable WRBs for use as the WRB layer of the multiple sheet building wrap include porous sheets, which include woven fabrics, such as sheets of woven fibers or tapes, or nonwoven fabrics, such as flash-spun plexifilamentary sheets, spunbond nonwoven sheets, spunbond-meltblown nonwoven sheets, spunbond-meltblown-spunbond (SMS) nonwoven sheets, asphalt-saturated papers, felts and laminates of any of the above including laminates of nonwoven or woven fabrics and a moisture vapor permeable film such as microporous film, perforated film or nonporous breathable film.

Examples of suitable flash-spun plexifilamentary WRBs are DuPont™ Tyvek® HomeWrap® and DuPont™ Tyvek® StuccoWrap®, commercially available from DuPont. Suitable flash spun plexifilamentary film-fibril sheet materials can be formed from a variety of polymeric compositions, such as, for example, polyolefins such as polypropylene or high density polyethylene, polyesters, or polyamides. The moisture vapor permeable sheet can be a laminate of a flash spun plexifilamentary sheet with one or more additional layers, such as a laminate comprising a flash spun plexifilamentary sheet and a melt-spun spunbond sheet. Flash spinning processes for forming web layers of plexifilamentary film-fibril strand material are disclosed in U.S. Pat. No. 3,081,519 (Blades et al.), U.S. Pat. No. 3,169,899 (Steuber), U.S. Pat. No. 3,227,784 (Blades et al.), U.S. Pat. No. 3,851,023 (Brethauer et al.).

The WRB layer can also be selected from sheets used in the construction industry including sheets of woven tapes that have been coated with a polymeric film layer and perforated.

Microporous films are well known in the art, such as those formed from a mixture of a polyolefin (e.g., polyethylene) and fine particulate fillers, which is melt-extruded, cast or blown into a thin film and stretched, either mono- or bi-axially to form irregularly shaped micropores which extend continuously through the thickness of the film. U.S. Pat. No. 5,955,175 discloses microporous films, which have nominal pore size of about 0.2 micrometer. Microporous films can be laminated to nonwoven or woven layers using methods known in the art such as thermal or adhesive lamination.

Perforated films are formed by casting or blowing a polymer into a film, followed by mechanically perforating the film, as generally disclosed in European Patent Publication No. EP 1 400 348 A2.

The moisture vapor permeable WRB for use in embodiments of the invention can be a low emissivity, breathable house wrap or a roof lining product having a metallized surface, such as those described in U.S. patent application Ser. No. 10/924,218.

### Intervening Layer (IL)

The multiple sheet building wrap of the invention includes a porous intervening layer adjacent the exterior surface of the WRB. The intervening layer is moisture vapor permeable and is preferably wettable. Whether a substrate is “wettable” or not depends on how much water beads up on the surface of the substrate. A material is non-wettable if beads of water form upon a surface and the contact angle between the surface and the water are greater than about 90 degrees. On the other hand, a substrate is wettable where water spreads over the surface and the contact angle of beads of water is less than about 90 degrees. The closer the contact angle is to zero, the more wettable the substrate is.

According to one embodiment, the intervening layer has a maximum pore size of between about 20 micrometers and about 150 micrometers, even between about 30 micrometers and about 150 micrometers, even between about 70 micrometers and about 120 micrometers, and is permeable to liquid water, so that if liquid water comes into direct contact with the intervening layer, it will readily pass through the intervening layer and drain through the drainage space between the WRB and the IL. The water is allowed to pass unimpeded as the WRB and the IL are not fully adhered across their entire adjoining surfaces. The pore size of the intervening layer is such that liquid water penetrates the intervening layer, but wet-applied facade materials such as wet stucco do not penetrate through the intervening layer when applied to a lath layer installed adjacent to the outer surface of the intervening layer. Stucco may adhere to or embed itself in the intervening layer, but for proper functioning of the building wrap; stucco should not penetrate through the intervening layer to the WRB.

The WRB and IL can be either not attached at all (e.g., a two-ply material which can be co-wound onto a roll and subsequently installed together) or attached in a discontinuous manner (i.e., not continuously adhered over significant surface area). Advantageously, if the two layers are attached, they can be attached by means of adhesive strips, adhesive spots (or spot gluing), or spot welding or ultrasonic bonding in a discrete pattern. The intervening layer has a hydrostatic head of less than 10 cm of water, even less than 6 cm of water, even less than 4 cm of water, and even less than 1 cm or less of water. The intervening layer should have sufficient abrasion resistance to prevent tearing of the intervening layer by manual application of stucco, and have sufficient strength to withstand the installation of the lath and application of stucco.

Suitable intervening layers include porous sheets, which include woven fabrics, such as sheets of woven fibers or tapes, nonwoven fabrics, such as flash-spun plexifilamentary sheets, spunbond nonwoven sheets, spunbond-meltblown nonwoven sheets, spunbond-meltblown-spunbond (SMS) nonwoven sheets, asphalt-saturated papers, felts and laminates of any of the above including laminates of nonwoven or woven fabrics and a moisture vapor permeable film such as microporous film, perforated film or nonporous breathable film.

The intervening layer can be made wettable by any of various known means, including coating the layer with a composition containing a surfactant in an amount sufficient to impart wettability to the intervening layer, incorporating a hydrophilic polymer additive into the layer and plasma treating the surface of the layer. It has been found that coating the intervening layer with a nonstick release coating including silicone or PTFE desirably facilitates drainage.

Spunbond sheets suitable for use as the intervening layer can be made by a process in which multiple spinning beams form multiple layers simultaneously. When formed in this way, one surface of the IL can be made to be more hydrophilic than the other by the inclusion of a spun-in hydrophilic additive. It has been found that the less hydrophilic surface preferably faces the stucco facade because the surface tends to pull less of the stucco through the IL, the more hydrophilic surface remains better protected from UV weathering, and better adhesion to tapes used in construction such as flashing materials utilizing butyl based adhesives.

Suitable perforated films for use as the intervening layer allow water to drain through perforations under low pressure drop and downward under gravity. Perforated films should be relatively hydrophobic in order to facilitate the flow of water downward rather than laterally. The size of the perforations is small to reduce stucco penetration without restricting the passage of water through the film. The intervening layer can consist of multiple layers of perforated film in which the layers have the same or different perforation size.

According to an alternative embodiment, the intervening layer can be a wettable moisture vapor permeable sheet that is not liquid permeable, or a combination of a wettable moisture vapor permeable sheet attached to a WRB that is not liquid permeable, so that the IL has a maximum pore size of between about 1 micrometer and about 150 micrometers. Although liquid water is not permitted to pass through the IL, it is directed through the IL by capillary action under gravity to the bottom of the wall. An example of such an IL is a carded fibrous layer or a multilayer combination of carded fibrous layers, e.g., layer(s) made from water-absorbent fibers, such as cellulosic (e.g., rayon) staple fibers, or a combination of cellulosic and polyester staple fibers in which the polyester fibers provide strength. Water-absorbent fibers also include fibers formed from any known water-absorbing polymer composition, such as those disclosed in PCT Publication Number WO97/005839 (Shipley). The carded fibrous layer(s) can be used as the IL either alone or in combination with a WRB layer. The carded fibrous layer(s) can be thermally bonded by incorporating a binder material in the form of binding fibers or powder binder and subjecting the layer(s) to heat to soften or melt the binder. The binding fibers can be single polymer component fibers or bicomponent fibers, e.g., having a lower melting polymer component sheath surrounding a higher melting polymer component core. The pore size of the IL can be controlled by varying the fiber density and denier of the staple fibers and/or the binding fibers used. The water-absorbent fibrous layer(s) preferably has a hydrostatic head of less than 10 cm.

In yet another embodiment, the IL can be a composite of a wettable moisture vapor permeable sheet and a water-absorbent fibrous layer(s), wherein the moisture vapor permeable sheet is located toward the interior and the water-absorbent fibrous layer(s) is located toward the exterior. The WRB can be a woven fabric, spunbond nonwoven sheet, spunlaced nonwoven sheet, spunbond-meltblown nonwoven sheet, spunbond-meltblown-spunbond nonwoven sheet or other nonwoven fabric, asphalt-saturated paper, felt, perforated coated sheets comprising woven tapes, laminates thereof, and laminates comprising a nonwoven or woven fabric and a porous moisture vapor permeable film. The manner in which the carded fibrous layer(s) or the composite and the WRB layer are combined must not impede the moisture vapor transmission of the combined intervening layer. For example, spot gluing is a suitable manner of attachment because moisture vapor is permitted to permeate through the IL where the layers are not glued. The adhesion of the water-absorbent fibrous layer(s) to the WRB can be controlled by varying the amount and/or composition of the binder material. For instance, when the IL includes a water-absorbent fibrous layer(s) containing polyethylene as a binder material and a WRB containing polyethylene (e.g., DuPont® Tyvek™ HomeWrap™), the water-absorbent fibrous layer(s) can be peeled away from the WRB during installation of the building wrap of the invention for flashing of windows and doors directly to the WRB layer.

An optional prefilter layer can be included over the IL to act as a further filter for the fines of the stucco to protect the IL from clogging and to further facilitate drainage of water. The prefilter layer can be a woven or nonwoven fabric which is permeable to liquid water, having essentially no resistance to hydrostatic pressure (i.e., hydrohead of about zero). The prefilter layer advantageously has a liquid flow rate of at least about 85 gal/min/ft² according to ASTM D 4491, and advantageously has an apparent opening size of about 0.425 mm according to ASTM 4751. Suitable materials for use as the prefilter layer include woven geotextiles and spunbond nonwovens. The optional prefilter layer can be either attached to the IL by spot welding or co-wound with the IL, so that it can be conveniently transported, handled and installed with the IL.

Advantageously, one or both of the sheets of the building wrap are durable when exposed to UV radiation, extreme temperatures and repeated exposure to water. The WRB and IL may each be formed from a variety of polymeric compositions. One or both of the sheets of the multiple sheet building wrap can be textured such as by creping to form vertical drainage channels between the WRB and the intervening layer. Alternatively, both of the sheets can be flat or untextured.

The multiple sheet building wrap can further include a layer of lath material attached to the IL. The lath material can be any flexible material capable of holding and supporting stucco or other wet-applied facade material. This allows the multiple sheet building wrap and the lath to be conveniently and economically installed together in one step. Alternatively, the WRB layer of the multiple sheet building wrap can be installed in a first step, followed by the installation of a composite sheet including the IL attached to a lath layer.

### Test Methods

In the non-limiting examples that follow, the following test methods were employed to determine various reported characteristics and properties. ASTM refers to the American Society of Testing Materials. ISO refers to the International Standards Organization. TAPPI refers to Technical Association of Pulp and Paper Industry.

Drainage Test was used to rate the degree of drainage of water when applied to test samples of building wrap having stucco applied. The stucco included 3 parts sand, 1 part Portland cement, and enough water to make a consistent slurry.

Rectangular test wall modules were constructed from OSB panels, forming a wall 48 in (122 cm) wide by 16 in (41 cm) high. Saran™ wrap (available from S. C. Johnson, Racine, Wis.) was placed on the OSB to prevent stucco from adhering to the wood. Four samples of building wrap were placed over the saran wrap. Wood trim pieces in the form of ⅜ in (0.95 cm) thick slats were screwed into the OSB along the perimeter of the wall. The upper horizontal piece of wood trim was wrapped in Saran™ wrap and attached to the module so that the building wrap samples were held in place. Toothpicks were placed under the upper piece of wood trim between the upper piece of wood trim and the building wrap so that syringe-injected drainage holes were formed in the stucco when the stucco cured. Stucco was evenly coated over the building wrap and allowed to cure for 3 to 7 days.

In order to measure the drainage characteristics for each building wrap sample, dyed water was added at approximately 1 ml/min to the toothpick holes at the top of the stucco coated modules. Subsequently, the stucco and building wrap were removed from the OSB wall of each testing module, and the interior of the wall was examined to determine how the water drained within the wall. The drainage characteristics of the building wrap samples were assessed based on the following characteristics:
i. Tendency for water to form puddles
ii. Water absorption into the building wrap or stucco
iii. Time for drainage to occur
iv. Lateral (horizontal) water movement during injection
Drainage ratings were assigned according to the following relative scale:
1=Water backing up, overflowing, lateral flow, ponding (forming non-draining, non-absorbing puddles of water at the injection interface)
2=Water backing up, overflowing, lateral flow, no immediate ponding
3=Water backing up slightly, some or no drainage, water absorbed by stucco before draining
4=Limited drainage, over time backing up and lateral flow may occur
5=No water backing up, lateral flow, limited drainage
6=Average drainage, some lateral flow
7=Slightly higher than average drainage, some lateral flow
8=Slightly higher than average drainage, no immediate lateral flow
9=Much higher than average drainage, no lateral flow, water not observed at bottom of wall
10=High drainage, water observed at bottom of wall

Hydrostatic Head (HH) was measured according to AATCC-127.

Moisture Vapor Transmission Rate (MVTR) was measured according to ASTM E-96 (Methods A and B).

Pore Size was measured using the Capillary Flow Porometer method and follows ASTM F316-86 and F778.

### EXAMPLES

Throughout the examples, wettability of a surface was determined by spraying the surface with water and observing the contact angles and the behavior of the water droplets on the surface.

### Examples 1-6 and Comparative Examples 1-3

To create examples of the invention, intervening layer samples were combined with a WRB layer of DuPont™ Tyvek® HomeWrap® spunbond polyethylene or DuPont™ Tyvek® StuccoWrap® spunbond polyethylene to form samples of building wrap which were subsequently subjected to drainage testing. The resulting drainage rating data are provided in Table 1. The 60 minute building paper, available from Fortifiber, Reno, Nev. was combined with a second layer of 60 minute building paper as is conventional in the trade, rather than a WRB layer of DuPont™ Tyvek® HomeWrap® spunbond polyethylene. Certain of the intervening layers were made from Brant™ SBPP (spunbond polypropylene) nonwoven fabric with a 100 gsm basis weight, available from Fitesa (Gravatai, Brazil). Some of the intervening layers were creped, and some of the intervening layers were treated with release coatings as indicated in Table 1. Release coatings 7442 and 7291 available from Huron Technologies (Leslie, Mich.); DryFilm WDL-5W™ PTFE based release coating from DuPont; and 1152, a wax-based release coating from Michelman (Cincinnati, Ohio), were used.

As can be seen from this data, the use of commercially available WRB samples as the intervening layer in the building wrap resulted in poor drainage, as did the use of 60 minute building paper. All of the spunbond polypropylene samples were found to provide good drainage as the intervening layer, with the exception of the sample coated with wax-based release coating (Comparative Example 4) which was found not to be wettable. Consistent with other test results herein, this indicates that samples which are not wettable do not provide good drainage. Spunbond polypropylene samples coated with other commercial release coatings (Examples 1-5) were found to be wettable and provide good drainage. It has been found that the use of wettable release coatings, such as those containing surfactants and other wettable components, promotes wettability, decreases the hydrohead of the sample and improves drainage.

TABLE 1

| | | Maximum | | |
|---|---|---|---|---|
| | | Pore Size of IL | | Drainage |
| Example | IL Sample | Sample (μm) | WRB Sample | Rating |
| Example 1 | Creped Brant ™, with 7291 | No data | HomeWrap ® | 10 |
| Example 2 | Brant ™ with release coating 7291 | 133 | HomeWrap ® | 9 |
| Example 3 | Brant ™ with release coating 7446 | 78 | HomeWrap ® | 9 |
| Example 4 | Creped Brant ™ with release coating 7446 | No data | HomeWrap ® | 10 |
| Example 5 | Brant ™ with DryFilm release coating | 128 | HomeWrap ® | 9 |
| Comparative | StuccoWrap ® with release coating 7291 | 45 | HomeWrap ® | 1 |
| Example 1 | | | | |
| Comparative | 60 minute building paper | 11 | 60 minute | 1 |
| Example 2 | | | building paper | |
| Comparative | HomeWrap ® with release coating 7291 | 32 | HomeWrap ® | 1 |
| Example 3 | | | | |
| Comparative | Brant ™ with wax based release coating | 108 | HomeWrap ® | 1 |
| Example 4 | M1152 | | | |

### Examples 7-9 and Comparative Examples 5-7

Building wrap samples were made from the IL and WRB sample combinations shown in Table 2 and subjected to drainage testing. Certain of the intervening layers were made from Novotex Duo™ SBPP (spunbond polypropylene) nonwoven fabric with a 100 gsm basis weight, available from Fitesa (Gravatai, Brazil). The Novotex Duo™ were made by a spunbond process in which two spinning beams deposit fibers in two layers, allowing a spun-in hydrophilic additive to be added to one of the two layers and not the other so that one surface can be more hydrophilic than the other. A testing module was constructed using each combination, stucco was applied and the module was tested for drainage. Some modules were constructed so that the less hydrophilic side of the IL contacted the stucco (Example 9), and others were constructed so that the more hydrophilic side of the IL contacted the stucco (Example 8).

It was found that Examples 8 and 9 which contained a hydrophilic additive as noted above had a hydrostatic head of about 4.9 cm. As can be seen from the results in Table 2, good drainage was attained by these examples as well as Example 7 which consisted of a carded layer of rayon and PET staple fibers attached to a WRB. Poorer drainage was demonstrated by the 60 minute building paper (Comparative Example 7) and Comparative Examples 5 and 6, which were non-wettable, that is, they did not contain a hydrophilic additive.

TABLE 2

| | | Maximum | |
|---|---|---|---|
| | | Pore Size of | |
| | | IL Sample | |
| Example | IL Sample | (μm) | WRB Sample |
| Example 7 | Rayon/PET attached to | 79 | StuccoWrap ® |
| | HomeWrap ® | | |
| Example 8 | Novotex Duo ™ (Wettable) | 114 | HomeWrap ® |
| Example 9 | Novotex Duo ™ (Wettable) | 114 | HomeWrap ® |
| Comparative | Novotex Duo ™ | 114 | HomeWrap ® |
| Example 5 | (Not wettable) | | |
| Comparative | Novotex Duo ™ | 114 | HomeWrap ® |
| Example 6 | (Not wettable) | | |
| Comparative | 60 minute building paper | 11 | 60 minute |
| Example 7 | | | building |
| | | | paper |

### Examples 10-12 and Comparative Examples 8-9

Building wrap samples were made from the IL and WRB sample combinations shown in Table 3 and subjected to drainage testing. In each case, the WRB sample was StuccoWrap®. Each of the intervening layers consisted of a multilayer carded nonwoven including one layer of rayon staple fibers and two layers of PET staple fibers. A testing module was constructed using each combination, stucco was applied and the modules were tested for drainage.

Examples 10 and 11 illustrate the importance of the percentage of the water-absorbent fibers when such fibers are included in the IL. Example 10, having 26% rayon fibers, demonstrated a good combination of drainage and good stucco curing. Because of the higher percentage of rayon in the IL of Example 11 (41%), more water was pulled from the stucco during curing than in Example 10, negatively impacting the final stucco facade. Because of the lower percentage of rayon (9%) in the IL of Comparative Example 8, the IL did not provide the same level of drainage performance as Examples 10 and 11.

To demonstrate the performance of the building wrap with prefilter layers, Example 12 included a woven polypropylene geotextile having a loose weave, (available from US Fabrics, Cincinnati, Ohio) and therefore having no resistance to hydrostatic pressure. The prefilter layer reduced the amount of fines from the stucco that became embedded in the IL, providing better drainage through the IL. The prefilter also reduced the effect of the water absorption of the rayon fibers on the stucco because it provided a separation layer between the IL and the stucco. In Comparative Example 9, a woven polypropylene slit film having a tight weave (available from Joe M. Almand, Inc., Atlanta, Ga.), and therefore having a resistance to hydrostatic pressure, was used as the prefilter layer. The tight weave of the prefilter would not permit water to pass through, therefore drainage was very poor.

TABLE 3

| | | % | | |
|---|---|---|---|---|
| | | Rayon of | | Drainage |
| Example | IL Sample | IL | Prefilter Layer | Rating |
| Example 10 | Rayon/PET | 26 | None | 8 |
| | (3 carded layers) | | | |
| Example 11 | Rayon/PET | 41 | None | 7 |
| | (3 carded layers) | | | |
| Comparative | Rayon/PET | 9 | None | 3 |
| Example 8 | (3 carded layers) | | | |
| Example 12 | Rayon/PET | 26 | Woven | 10 |
| | (3 carded layers) | | polypropylene | |
| | | | geotextile) | |
| Comparative | Rayon/PET | 26 | Woven | 1 |
| Example 9 | (3 carded layers) | | polypropylene | |
| | | | slit film | |

What is claimed is:

1. A multiple sheet building wrap for wrapping the structural components and optional sheathing of a building in order to protect the structural components and optional sheathing from moisture, the wrap comprising:
a moisture vapor permeable water-resistive barrier that is adjacent to the building; and
a wettable intervening layer, comprising a porous, liquid permeable sheet facing away from the building having a maximum pore size of between about 20 micrometers and about 150 micrometers and having a hydrostatic head of less than 10 cm selected from the group consisting of woven fabrics, spunbond nonwoven sheets, spunlaced nonwoven sheets, spunbond-meltblown nonwoven sheets, water-absorbent fibrous layers, spunbond-meltblown-spunbond nonwoven sheets and perforated films;
wherein the water resistive barrier and the intervening layer are not fully adhered, so that a drainage space is provided between the water resistive barrier and the intervening layer through which liquid water can pass.

2. The multiple sheet building wrap of claim 1, wherein the moisture vapor permeable water-resistive barrier is selected from the group consisting of asphalt-saturated papers, felts, woven fabrics, flash-spun plexifilamentary sheets, spunbond nonwoven sheets, spunbond-meltblown nonwoven sheets, spunbond-meltblown-spunbond nonwoven sheets, perforated coated sheets comprising woven tapes, laminates thereof, and laminates comprising a nonwoven or woven fabric and a porous moisture vapor permeable film.

3. The multiple sheet building wrap of claim 1, wherein the intervening layer comprises a coating comprising a surfactant in an amount sufficient to impart wettability to the intervening layer.

4. The multiple sheet building wrap of claim 1, wherein the intervening layer comprises a hydrophilic polymer additive in an amount sufficient to impart wettability to the intervening layer.

5. The multiple sheet building wrap of claim 1, wherein the intervening layer is plasma treated to impart wettability.

6. The multiple sheet building wrap of claim 1, wherein the intervening layer comprises a release coating comprising silicone or PTFE and a surfactant in an amount sufficient to impart wettability to the intervening layer.

7. The multiple sheet building wrap of claim 1, wherein the intervening layer comprises a more hydrophilic surface and a less hydrophilic surface and wherein the more hydrophilic surface faces the water resistive barrier.

8. The multiple sheet building wrap of claim 1, wherein the intervening layer is a multilayer composite comprising a water-absorbent fibrous layer(s) and a layer selected from the group consisting of woven fabrics, spunbond nonwoven sheets, spunlaced nonwoven sheets, spunbond-meltblown nonwoven sheets, and spunbond-meltblown-spunbond nonwoven sheets.

9. The multiple sheet building wrap of claim 8, wherein the water-absorbent fibrous layer(s) comprises a carded fibrous layer comprising a combination of water-absorbent fibers and polyester fibers.

10. A multiple sheet building wrap for wrapping the structural components and optional sheathing of a building in order to protect the structural components and optional sheathing from moisture, the wrap comprising:
(a) a moisture vapor permeable water-resistive barrier that is adjacent to the building and
(b) an intervening layer that is positioned outside the water resistive barrier comprising:
(i) a moisture vapor permeable sheet having a maximum pore size of between about 1 micrometer and about 150 micrometers selected from the group consisting of asphalt-saturated papers, felts, nonwoven fabrics, perforated coated sheets comprising woven tapes, perforated films, laminates thereof, and laminates comprising a nonwoven or woven fabric and a porous moisture vapor permeable film; and
(ii) a wettable water-absorbent fibrous layer(s) having a hydrostatic head of less than 10 cm;
wherein the moisture vapor permeable sheet is located toward the inside and the water-absorbent fibrous layer(s) is located toward the outside and are combined in such manner that the moisture vapor permeability of the intervening layer is not impeded.

11. The multiple sheet building wrap of claim 10, wherein the water resistive barrier and the intervening layer are not fully adhered so that a drainage space is provided between the water resistive barrier and the intervening layer through which liquid water can pass.

12. The multiple sheet building wrap of claim 10, wherein the water-absorbent fibrous layer(s) comprises a carded fibrous layer comprising water-absorbent fibers or a combination of water-absorbent fibers and polyester fibers.

13. The multiple sheet building wrap of claim 1 or 10, further comprising a liquid permeable prefilter layer adjacent the intervening layer, wherein the prefilter layer has essentially no resistance to hydrostatic pressure.

14. The multiple sheet building wrap of claim 1 or 10, further comprising a lath layer adjacent the intervening layer, wherein the water resistive barrier, the intervening layer and the lath layer are attached.

15. A process of wrapping the structural components and optional sheathing of a building in order to protect the building structure from moisture, comprising wrapping the structural components and optional sheathing of the building with the multiple sheet building wrap of claim 1 or 10.

16. An external wall assembly of a building comprising:
structural components providing structural support for the building;
optional sheathing material surrounding the structural components;
a multiple sheet building wrap, according to claim 1 or 10 surrounding the structural components and optional sheathing material wherein the water-resistive barrier is the inner layer and the intervening layer is the outer layer;
a lath layer capable of supporting a wet-applied facade material surrounding the multiple sheet building wrap contacting the intervening layer; and
wet-applied facade material contacting the lath layer and forming the outermost layer of the external wall assembly.
